(19) United States
(12) Patent Application Publication
(10) Pub. No.: US 2019/0262236 A1
(43) Pub. Date: Aug. 29, 2019

(54) BABY BOTTLE HAVING COMBINATION PACIFIER NIPPLE

(71) Applicant: Shahin Shamsian, Encino, CA (US)

(72) Inventors: Shahin Shamsian, Encino, CA (US); Lewis Anten, Encino, CA (US); Gregory Edward Mote, Big Bear Lake, CA (US)

(73) Assignee: Shahin Shamsian

(21) Appl. No.: 16/285,790

(22) Filed: Feb. 26, 2019

Related U.S. Application Data
(60) Provisional application No. 62/635,927, filed on Feb. 27, 2018.

(51) Int. Cl. A61J 11/04; A61J 11/00; A61J 17/00

(52) U.S. Cl. CPC A61J 11/04; A61J 9/00; A61J 17/001; A61J 11/0055

(57) ABSTRACT

A baby bottle having a nipple that can have the nipple remain in the mouth of a sleeping baby to act as a pacifier, but have the rest of the bottle be removed easily.

### BACKGROUND OF THE INVENTION

If a baby falls asleep with the bottle of milk in the baby's mouth it can lead to tooth decay (“Rampant Caries”). At the present time, in order to prevent this condition, it is necessary to remove the baby bottle from the mouth of the baby when the baby is asleep. The removal of the baby bottle and nipple from the mouth of the baby will ordinarily wake up the baby. If pacifiers are used, then a pacifier would need to be placed into the baby's mouth while the baby is sleeping after the removal of the bottle.

### SUMMARY OF THE INVENTION

The present invention consists of a baby bottle with a nipple permitting the easy removal of the bottle permitting the nipple to remain in the mouth of a sleeping baby to act as a pacifier. The top of the bottle is sealed closed when separated from the nipple so any milk in the bottle does not spill out. In an alternative embodiment, the flow of milk contained in the bottle when the baby is sleeping is closed off without removing the bottle itself. It is also desirable to prevent the baby from sucking in air once the milk is finished or the bottle is separated from the nipple portion. In the alternative embodiment, air is also prevented from being sucked in by the baby when sucking on the nipple after the flow of milk is stopped.

### BRIEF DESCRIPTIONS OF THE DRAWINGS

FIG. 1 is an exploded view of the components (a)-(f) of the first embodiment of the present invention.

FIG. 2 is a side sectional view of the milk flow closure mechanism in an open position of the first embodiment of the present invention.

FIG. 3 is a side sectional view of the first embodiment of the present invention with the nipple portion separated from the bottle portion.

FIG. 4 is a side sectional view of an alternative embodiment of the present invention for preventing milk or air from passing to the nipple portion.

FIG. 5 is a top view of an alternative embodiment of the present invention showing the first of the closure components of FIG. 4.

FIG. 6 is a top view of an alternative embodiment of the present invention showing the second of the closure components of FIG. 4.

### DETAILED DESCRIPTION OF THE INVENTION

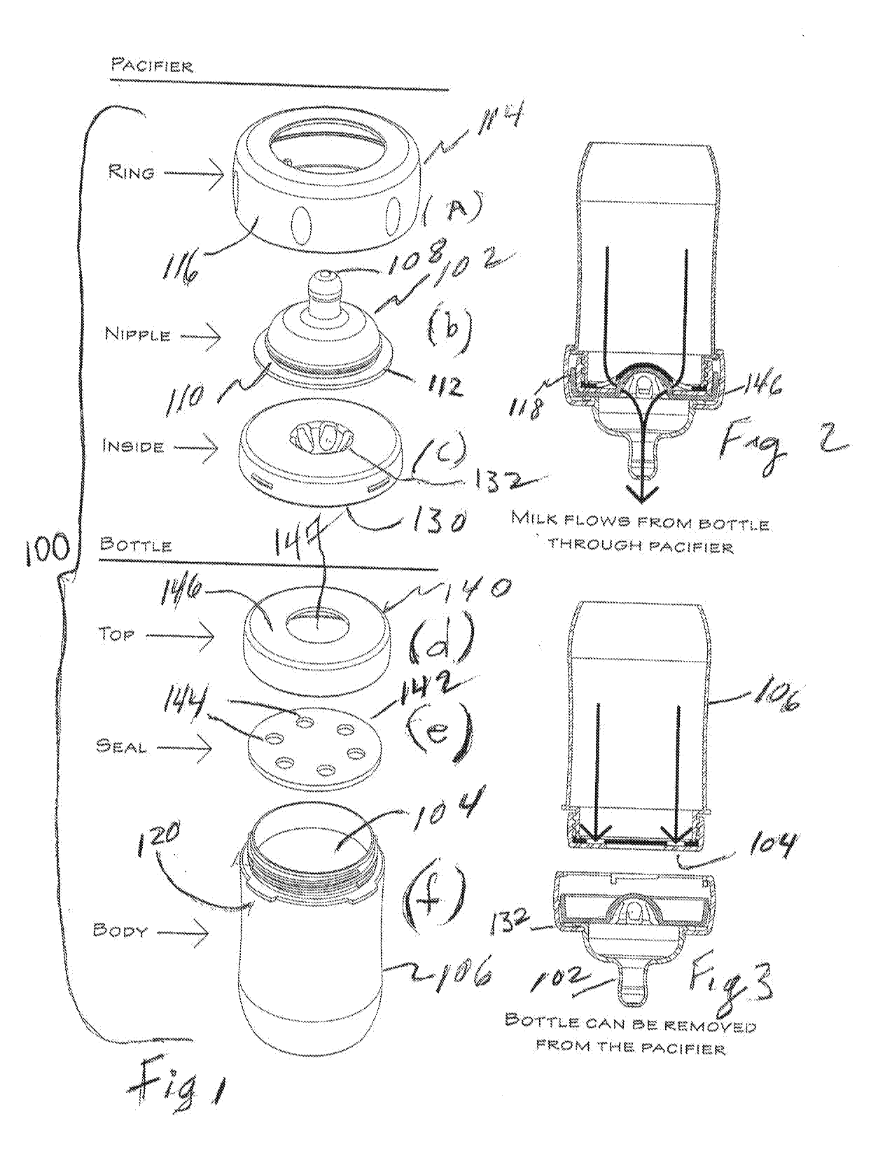

Referring to FIG. 1, a baby bottle 100 having a nipple portion 102 attached to the opening 104 in the bottle portion 106 is shown. The bottle portion 106 is typically made of glass or a relatively rigid plastic material. The nipple portion 102 is made of a flexible plastic material such as medical grade silicone. The nipple portion 102 has a small opening 108 at its top for the baby to suck milk contained in the bottle 106. The bottom 110 of the nipple portion 102 has a circumferential flange 112 and is typically the size of the opening 104 of the bottle 106. The nipple portion 102 is surrounded by a circular ring 114 made of a rigid plastic that has a depending collar 116 with internal threads 118 that correspond to external threads 120 on the top circumference of the bottle 106. The threads 120 of the present invention are bayonet type threads for easy removal of the nipple portion 102 from the bottle portion 106.

Referring to FIGS. 1, 2 and 3, below the nipple portion 102 is a circular member 130 having a series of depending central rigid projections 132. The member 130 fits between an intermediate member 140 having a central opening 147 and the nipple portion 102. Beneath the intermediate member 140 is a flexible seal 142 having a series of peripheral openings 144 held in place by the ring 116. The depending projections 132 flexes the original shape of the flexible sealing member 142 downward by permitting milk in the bottle to flow as shown in FIG. 2 through the openings 144, into the nipple portion 102. When the nipple portion 102 is separated from the bottle portion 106, the upper surface 146 of the intermediate member 140 prevents milk from flowing through the openings 144 in the flexible sealing member 142 when it returns to its original flat shape as shown in FIG. 3.

Bayonet thread attachment devices are well known and any bayonet type device can be used. The use of a bayonet type thread permits the easy removal of the nipple portion from the bottle portion so as to not wake up the baby. While a bayonet type thread is shown and described, other easy removal type of attachment devices, such as a push button can be used. These types of easy removal are preferable to a conventional threaded arrangement that would require many turns of the bottle to separate it from the nipple causing the baby to wake up. Once the baby bottle is removed the nipple now acts as a pacifier for the sleeping baby.

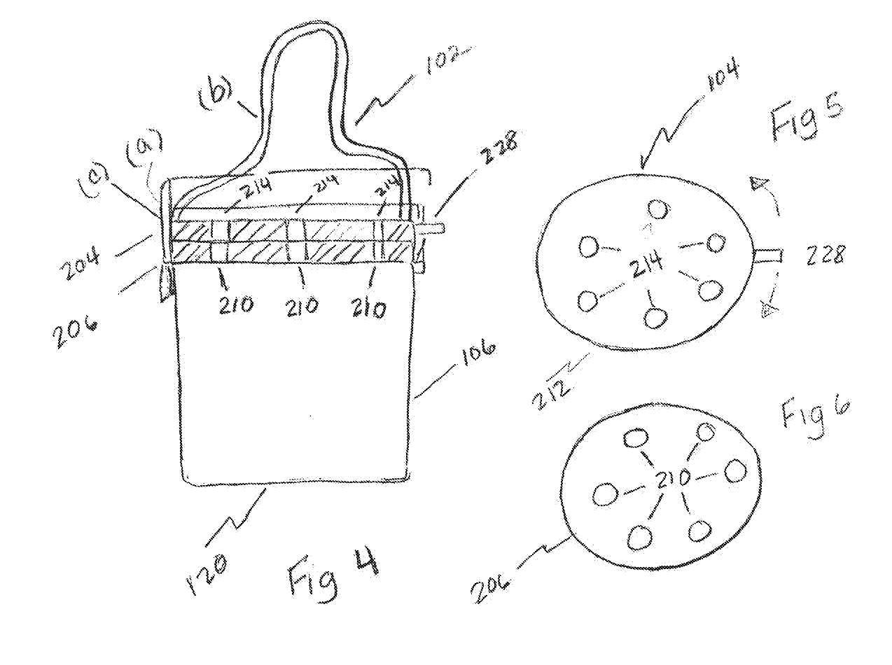

Referring to FIGS. 4-6, an alternative embodiment is shown where the bottle is sealed, preventing milk or air from entering into the nipple portion 102. A first fixed closure plate 206 has a series of openings 210 around its periphery. A second closure plate 212 is positioned over the first closure plate 206 also has a series of openings 214. The second closure plate 212 is rotatable about its central axis by means of a handle 228 as shown in FIG. 5. The openings in the first closure plate 206 are offset from the series of openings 214 in the second closure plate 212 so that when in its first position the openings 214 correspond with the openings 210 permitting milk to flow through the openings 210 and 214 into the nipple portion 102. When the second closure plate 212 is rotated so that the openings 214 in the closure plate are not aligned with the openings 210 in the first closure plate 206, milk or air is prevented from entering the nipple portion 102. The closure plates 206 and 212 are positioned above the intermediate member 140 around the nipple portion 102 shown in FIG. 1. All of the components of the present invention are easily separated for ease of cleaning.

In an alternative embodiment, instead of using a handle 228 to rotate the second closure plate 212, a second closure plate can be attached to the inner portion of the intermediate member 140 and rotated so as to be aligned or not aligned with the openings 210 and 214.

While the present invention has been disclosed in detail with regards to the preferred embodiment and alternative embodiments, it is appreciated that other variations of the present invention may be devised which do not depart from the inventive concept of the present invention.

1. A baby bottle comprising a nipple portion and a bottle portion; the nipple portion being separable from the bottle potion; the bottle portion having a cap which permits fluid in the bottle portion to pass into the nipple portion when attached to the nipple portion and preventing fluid from passing out of the bottle portion when separated from the nipple portion.

2. A baby bottle comprising a bottle portion having a top opening; a nipple portion, the nipple portion being separable from the bottle portion; the nipple portion having an upper opening and a lower opening; the bottle portion having a seal that seals the opening in the bottle portion when the bottle portion is separated from the nipple portion and does not seal the opening in the bottle portion when the bottle portion is attached to the nipple portion.

3. The baby bottle of claim 2 in which the seal is flexible and has at least one opening and is movable from a first closed position to a second open position.

4. The baby bottle of claim 3 in which the seal consists of two members, the first member having at least one opening and a second member covering said opening when the nipple portion is not attached to the bottle portion and not covering the opening when the nipple portion is attached to the bottle portion.

5. The baby bottle of claim 3 in which the seal comprises a plurality of plates, each plate having holes, said plates movable in relationship to one another.

6. The baby bottle of claim 2 in which the lower opening of the nipple portion is sealed when separated from the bottle portion.
